(19) United States
(12) Patent Application Publication
(10) Pub. No.: US 2014/0260318 A1
(43) Pub. Date: Sep. 18, 2014

(54) SIDE SEAL SLOT FOR A COMBUSTION LINER

(71) Applicant: GENERAL ELECTRIC COMPANY, Schenectady, NY (US)

(72) Inventors: Christopher Paul Willis, Liberty, SC (US); Richard Martin DiCintio, Simpsonville, SC (US); Ronnie Ray Pentecost, Travelers Rest, SC (US); Christopher Crookshanks, Cumming, GA (US)

(73) Assignee: GENERAL ELECTRIC COMPANY, Schenectady, NY (US)

(21) Appl. No.: 13/845,617

(22) Filed: Mar. 18, 2013

(51) Int. Cl. F02C 7/20

(52) U.S. Cl. CPC F02C 7/20
USPC 60/796

(57) ABSTRACT

A side seal slot extends along a one side of an aft frame for a combustion liner of a gas turbine. The side seal slot is at least partially defined between a downstream wall and an upstream wall that extend outward from the first side of the aft frame. A first segment of the upstream wall extends from an inner portion of the aft frame towards an outer portion of the aft frame at a first outward distance from the first side. A second segment of the upstream wall extends from the first segment to the outer portion of the aft frame at a second outward distance from the first side. The second segment of the upstream wall at least partially defines a side seal guide feature to allow for axial insertion of a bottom portion of a side seal into the side seal slot.

### FIELD OF THE INVENTION

The present invention generally involves a combustor of a gas turbine. More specifically, the invention relates to a side seal slot of an aft frame that is disposed at an aft end of a combustion liner.

### BACKGROUND OF THE INVENTION

Turbine systems are widely used in fields such as power generation and aviation. A typical gas turbine includes a compressor section, a combustion section downstream from the compressor section and a turbine section downstream from the combustion section. At least one shaft extends axially at least partially through the gas turbine. A generator/motor may be coupled to the shaft at one end. The combustion section generally includes a compressor discharge casing and a plurality of combustors arranged in an annular array around the casing. The turbine section includes an outer turbine shell or casing that is connected to the compressor discharge casing. The compressor discharge casing and the turbine casing at least partially define a high pressure plenum that surrounds at least a portion of each of the combustors. The high pressure plenum is in fluid communication with the compressor section.

Each combustor includes an end cover that is coupled to the casing. At least one fuel nozzle extends axially downstream from the end cover and at least partially through a cap assembly that extends radially within the casing. An annular liner such as a combustion liner or a transition duct extends downstream from the cap assembly. A support frame or aft frame circumferentially surrounds a downstream end of the liner. The downstream end of the liner and/or the aft frame terminates at a point that is generally adjacent to a first stage nozzle which at least partially defines an inlet to the turbine section.

The aft frame generally includes an inner portion, an outer portion, and a pair of opposing side portions. The aft frame of each combustor of the plurality of combustors is generally arranged such that one side portion of one aft frame is adjacent to one side portion of another aft frame. When the aft frames and/or the combustors are arranged in such a configuration, a gap is defined between the sides of each adjacent aft frame. The gap extends between the adjacent sides of the aft frames and radially between the inner and outer portions of the adjacent aft frames with respect to an axial center line of the gas turbine. As a result, a side seal slot is defined in each side portion of each aft frame to support a side seal to prevent or reduce leakage of a high pressure working fluid between the adjacent aft frames. During installation and/or repair of the combustor, the generally rectangular shaped side seal is fed into on opening at a top or a bottom portion of the side seal slots of two adjacent aft frames. The width of the side seal is generally sufficient to provide a seal between the adjacent side portions of the adjacent aft frames, and the length of the side seal is sufficient to extend radially between the inner portions and the outer portions of the adjacent aft frames.

The side seals are subject to damage during installation. For example, bending and/or twisting of the side seal can result in permanent deformation, thereby potentially reducing the mechanical life of the side seal. In addition, the deformed side seal may result in leakage of the high pressure working fluid between the high pressure plenum and the hot gas path, thereby impacting the overall performance and/or efficiency of the gas turbine. In order to prevent damage to the side seal during installation, there must be sufficient radial clearance between the opening in the seal slot and the compressor discharge casing and/or the outer turbine shell to allow the side seal to be inserted into the side seal slot without bending or otherwise deforming the seal.

In many gas turbines, there is generally sufficient radial clearance to insert the side seals without bending or twisting. However, in efforts to decrease the overall size and/or circumference of the gas turbine, the radial clearance between the opening of the side seal slot and the compressor discharge casing and/or the turbine shell is generally not sufficient to allow installation of the side seals without bending, twisting or otherwise deforming the side seal. Therefore, an aft frame that includes a side seal slot that allows installation of the side seal without damaging the side seal, particularly where radial clearance is limited would be useful.

### BRIEF DESCRIPTION OF THE INVENTION

Aspects and advantages of the invention are set forth below in the following description, or may be obvious from the description, or may be learned through practice of the invention.

One embodiment of the present invention is an aft frame for an annular combustion liner of a gas turbine. The aft frame includes an inner portion that is radially separated from an outer portion, and a pair of opposing sides that extend between the inner and the outer portions. A side seal slot extends along a first side of the pair of opposing sides between the inner and the outer portions of the aft frame. The side seal slot is at least partially defined between a downstream wall and an upstream wall that extend outward from the first side of the aft frame. A first segment of the upstream wall extends from the inner portion towards the outer portion of the aft frame at a first outward distance from the first side. A second segment of the upstream wall extends from an intersection point with the first segment towards the outer portion of the aft frame at a second outward distance from the first side. The second segment of the upstream wall at least partially defines a side seal guide feature that allows for axial insertion of a bottom portion of a side seal into the side seal slot.

Another embodiment of the present invention is a combustor for a gas turbine. The gas turbine includes an end cover that is coupled to a casing that at least partially surrounds the combustor. A fuel nozzle extends from the end cover and at least partially through a cap assembly. The cap assembly extends radially and axially within the casing downstream from the end cover. An annular liner includes a forward end and an aft end where the forward end surrounds a downstream end of the cap assembly. The aft end of the liner is disposed downstream from the forward end. An aft frame extends circumferentially around and radially outward from the downstream end of the liner to define an outlet from the liner. The aft frame comprises an inner portion that is radially separated from an outer portion, and a pair of opposing sides that extend between the inner and the outer portions. A side seal slot extends along a first side of the pair of opposing sides between the inner and the outer portions of the aft frame. The side seal slot is at least partially defined between a downstream wall and an upstream wall that extend outward from the first side. A first segment of the upstream wall extends from the inner portion of the aft frame towards the outer portion at a first outward distance from the first side. A second segment of the upstream wall extends from a point of intersection with the first segment towards the outer portion of the aft frame at a second outward distance. The second segment of the upstream wall at least partially defines a side seal guide feature to allow for axial insertion of a bottom portion of a side seal into the side seal slot.

The present invention may also include a gas turbine having a compressor, a combustion section positioned downstream from the compressor and a turbine section that is positioned downstream from the combustion section. The combustion section includes a compressor discharge casing that at least partially surrounds the combustion section. A combustor extends through the compressor discharge casing towards an inlet to the turbine section. An end cover is coupled to the compressor discharge casing, and an annular cap assembly is disposed downstream from the end cover within the compressor discharge casing. An annular liner has a forward end that surrounds a downstream end of the cap assembly, and a downstream end that terminates adjacent to the inlet of the turbine section. The downstream end of the liner includes an aft frame that defines an outlet at the downstream end of the liner. The aft frame includes an inner portion that is radially separated from an outer portion, and a pair of opposing sides that extend between the inner and the outer portions. A side seal slot extends along a first side of the pair of opposing sides between the inner and the outer portions of the aft frame. The side seal slot is at least partially defined between a downstream wall and an upstream wall that extend outward from the first side. A first segment of the upstream wall extends from the inner portion of the aft frame towards the outer portion of the aft frame at a first outward distance from the first side. A second segment of the upstream wall extends from a point of intersection with the first segment to the outer portion of the aft frame at a second outward distance. The second segment of the upstream wall at least partially defines a side seal guide feature that allows for axial insertion of a bottom portion of a side seal into the side seal slot.

Those of ordinary skill in the art will better appreciate the features and aspects of such embodiments, and others, upon review of the specification.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a functional block diagram of an exemplary gas turbine within the scope of the present invention;

FIG. 2 is a simplified side cross-section view of an exemplary combustor according to various embodiments of the present invention;

FIG. 3 provides a perspective view of a portion of the combustor as shown in FIG. 2;

FIG. 4 provides an enlarged perspective view of an aft frame portion of the combustor as shown in FIG. 3, according to one embodiment of the present invention;

FIG. 5 provides a backside view of the aft frame as shown in FIG. 3, according to one embodiment of the present invention;

FIG. 6 provides an enlarged backside view of a portion of the aft frame as shown in FIG. 5, according to one embodiment of the present invention;

FIG. 7 provides a side view of the aft frame as shown in FIG. 6, according to one embodiment of the present invention;

FIG. 8 provides a side view of the aft frame as shown in FIG. 6, according to one embodiment of the present invention;

FIG. 9 provides a side view of the aft frame as shown in FIG. 6, according to one embodiment of the present invention;

FIG. 10 provides a side view of the aft frame as shown in FIG. 6, according to one embodiment of the present invention;

FIG. 11 provides a backside view of two adjacent aft frames as shown in FIG. 5; and

FIG. 12 provides a backside view of the two adjacent aft frames as shown in FIG. 11.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention. As used herein, the terms “first”, “second”, and “third” may be used interchangeably to distinguish one component from another and are not intended to signify location or importance of the individual components. The terms “upstream” and “downstream” refer to the relative direction with respect to fluid flow in a fluid pathway. For example, “upstream” refers to the direction from which the fluid flows, and “downstream” refers to the direction to which the fluid flows. The term “radially” refers to the relative direction that is substantially perpendicular to an axial centerline of a particular component, and the term “axially” refers to the relative direction that is substantially parallel to an axial centerline of a particular component.

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents. Although exemplary embodiments of the present invention will be described generally in the context of a combustor incorporated into a gas turbine for purposes of illustration, one of ordinary skill in the art will readily appreciate that embodiments of the present invention may be applied to any combustor incorporated into any turbomachine and is not limited to a gas turbine combustor unless specifically recited in the claims.

Referring now to the drawings, wherein identical numerals indicate the same elements throughout the figures, FIG. 1 provides a functional block diagram of an exemplary gas turbine 10 that may incorporate various embodiments of the present invention. As shown, the gas turbine 10 generally includes an inlet section 12 that may include a series of filters, cooling coils, moisture separators, and/or other devices to purify and otherwise condition a working fluid (e.g., air) 14 entering the gas turbine 10. The working fluid 14 flows to a compressor section where a compressor 16 progressively imparts kinetic energy to the working fluid 14 to produce a compressed working fluid 18 at a highly energized state.

The compressed working fluid 18 is mixed with a fuel 20 from a fuel supply 22 to form a combustible mixture within one or more combustors 24. The combustible mixture is burned to produce combustion gases 26 having a high temperature and pressure. The combustion gases 26 flow through a turbine 28 of a turbine section to produce work. For example, the turbine 28 may be connected to a shaft 30 so that rotation of the turbine 28 drives the compressor 16 to produce the compressed working fluid 18. Alternately or in addition, the shaft 30 may connect the turbine 28 to a generator 32 for producing electricity. Exhaust gases 34 from the turbine 28 flow through an exhaust section 36 that connects the turbine 28 to an exhaust stack 38 downstream from the turbine 28. The exhaust section 36 may include, for example, a heat recovery steam generator (not shown) for cleaning and extracting additional heat from the exhaust gases 34 prior to release to the environment.

FIG. 2 provides a cross-section side view of a portion of an exemplary gas turbine 10 that may encompass various embodiments within the scope of the present disclosure. As shown in FIG. 2, a combustion section 40 generally includes a compressor discharge casing 42 that at least partially encases each combustor 24. The compressor discharge casing 42 at least partially defines a high pressure plenum 44 that is in fluid communication with the compressor 16. The compressor discharge casing 42 at least partially defines an opening 46 for installing the combustor 24. The high pressure plenum 44 surrounds at least a portion of each combustor 24. In particular embodiments, the high pressure plenum 44 is further defined by a portion of an outer turbine shell 48 that circumferentially surrounds an inner turbine shell 50.

As shown in FIG. 2, each combustor 24 generally includes a radially extending end cover 52. The end cover 52 may be coupled either directly or indirectly to the compressor discharge casing 42. One or more axially extending fuel nozzles 54 extend downstream from an inner surface 56 of the end cover 52. An annular spacer casing 58 may be disposed between the end cover 52 and the compressor discharge casing 42. The end cover 52 and/or the spacer casing 58 may at least partially define a head end plenum 60 within the combustor 24. An annular cap assembly 62 extends radially and axially within the spacer casing 58 and/or within the compressor discharge casing 42. The cap assembly 62 generally includes a radially extending base plate 64, a radially extending cap plate 66, and an annular shroud 68 that extends between the base plate 64 and the cap plate 66. In particular embodiments, the axially extending fuel nozzles 54 extend at least partially through the base plate 64 and/or the cap plate 66 of the cap assembly 62.

In particular embodiments, as shown in FIG. 2, an annular liner 80 such as a combustion liner or a transition duct at least partially surrounds a downstream end 82 of the cap assembly 62. The liner 80 extends downstream from the cap assembly 62 towards a first stage 84 of stationary nozzles or vanes 86. The liner 80 at least partially defines a hot gas path 87 through the high pressure plenum 44. The liner 80 may be at least partially surrounded by one or more flow sleeves 88 and/or impingement sleeves 90. In particular embodiments, one or more late lean fuel injector passages 92 may extend generally radially through the liner 80.

FIG. 3 provides a perspective view of a portion of the combustor 24 as shown in FIG. 2, which may include various embodiments of the present invention. In particular embodiments, as shown in FIG. 2, a support frame or aft frame 94 is disposed at a downstream end or aft end 96 of the liner 80. As shown in FIG. 3, the aft frame 94 extends at least partially circumferentially around and radially outward from at least portion of the aft end 96 of the liner 94. As shown in FIG. 3, the aft frame 94 generally includes an inner portion 98, an outer portion 100 that is radially separated from the inner portion 98 with respect to an axial centerline 102 of the aft frame 94, and a pair of opposing sides 104 that extend generally radially between the inner portion 98 and the outer portion 100 with respect to the axial center line 102 of the aft frame 94.

The pair of opposing sides 104 generally comprises a first side 106 and a second side 108. The first side 106 and the second side 108 of the pair of opposing sides 104 extend between the inner portion 98 and the outer portion 100 of the aft frame 94. The inner portion 98, outer portion 100 and the first side 106 and the second side 108 of the pair of opposing sides 104 define an outlet 110 at the aft end 96 of the liner 80 for directing the combustion gases 26 (FIG. 1) towards the first stage 84 (FIG. 2) of the stationary nozzles 86 (FIG. 2) and into the turbine 28 (FIG. 2).

The inner portion 98 and the outer portion 100 may be generally arcuate shaped or curved so that the aft frame 94 of adjacent combustors 24 may be arranged in an annular array around the shaft (FIG. 1) of the gas turbine 10 (FIG. 1) and or the compressor discharge casing 42 (FIG. 2). The aft frame 94 may be welded to the liner 80 or, in the alternative, the aft frame 94 and the liner 80 may be cast as a singular component. In particular embodiments, as shown in FIG. 2, at least one of the flow sleeve(s) 88 and/or the impingement sleeve(s) 90 may be coupled to the aft frame 94.

FIG. 4 provides an enlarged perspective view of a portion of the aft frame 94 as shown in FIG. 3, according to at least one embodiment of the present disclosure, FIG. 5 provides a backside view of the aft frame 94 as shown in FIG. 3 and FIG. 6 provides an enlarged backside view of a portion of the aft frame as shown in FIG. 5. As shown in FIG. 4, the aft frame 94 includes a side seal slot 112 that extends along the first side 106 of the pair of opposing sides 104. The side seal slot 112 extends at least partially between the inner portion 98 and the outer portion 100 of the aft frame 94. Although the side seal slot 112 will be generally described with reference to the first side 106 of the pair of opposing sides 104 of the aft frame 94 for clarity, it should recognized by one of ordinary skill in the art that either or both of the first and the second sides 106, 108 of the opposing sides 104 of the aft frame 94 may include the side seal slot 112 as described herein. For example, as shown in FIG. 5, the first side 106 may include a first side seal slot 114 and the second side 108 may include a second side seal slot 116.

As shown in FIG. 4, the side seal slot 112 is at least partially defined between a downstream wall or aft wall 118 and an upstream wall or forward wall 120 of the aft frame 94. The upstream wall 120 and the downstream wall 118 extend outward from and substantially perpendicular to an inner surface 122 of the first side 106 of the pair of opposing sides 104. The upstream wall 120 and the downstream wall 118 extend at least partially between the inner portion 98 and the outer portion 100 of the aft frame 94. In particular embodiments, the downstream wall 118 extends from the inner portion 98 to the outer portion 100 of the aft frame 94.

In one embodiment, as shown in FIG. 4, the upstream wall comprises a first segment 122 and a second segment 124. The first segment 124 extends along the first side 106 of the pair of opposing sides 104 from the inner portion 98 towards the outer portion 100 of the aft frame 94, and a second segment 126 of the upstream wall 120 extends from an intersection point 128 with the first segment 124 towards the outer portion 100 of the aft frame 94. The first segment 124 defines a first outer surface 130, the second segment 126 defines a second outer surface 132 and the downstream wall 118 defines a third outer surface 134.

In particular embodiments, as shown in FIG. 6, the first segment 124 of the upstream wall 120 extends outward from the inner surface 122 of the first side 106 of the aft frame 94 a first outward distance 136. The first outward distance being defined between the inner surface 122 and the first outer surface 130 of the first segment 124. The second segment 126 of the upstream wall 120 extends outward from the inner surface 122 of the first side 106 of the aft frame 94 a second outward distance 138. The second outward distance being defined between the inner surface 122 and the second outer surface 130 of the second segment 124. The downstream wall 118 extends outward from the inner surface 122 of the first side 106 of the aft frame 94 a third outward distance 140. The third outward distance 140 being defined between the inner surface 122 and the third outer surface 130 of the downstream wall 118. Each of the first outward distance 136, the second outward distance 138 and the third outward distance 140 is measured with respect to a line that is substantially perpendicular to the inner surface 122. In one embodiment, the third outward distance 140 of the downstream wall 118 is greater than the second outward distance 138 of the second segment 126 of the upstream wall.

In particular embodiments, as shown in FIG. 6, the first outward distance 136 of the first segment 124 is greater than the second outward distance 138 of the second segment 126, thereby defining a step 142 at the intersection point 128 of the first segment 124 and the second segment 126 of the upstream wall 120 between the first outer surface 130 and the second outer surface 132. As a result, the second segment 126 at least partially defines a side seal guide feature or key way 144, as shown in FIG. 4, in the first side 106 of the pair of opposing sides 104 of the aft frame 94.

In particular embodiments, as shown in FIG. 4, the step 142 is configured to guide a bottom portion of a side seal 146, as shown in FIG. 7, into the side seal slot 112 in a substantially axial and/or a radial direction with respect to the axial centerline 102 of the aft frame 94. For example, as shown in FIG. 4, the step 142 may be chamfered. In addition or in the alternative, the step 142 may be curved or rounded to guide the bottom portion 144 of the side seal 146 into the side seal slot 112 during installation.

FIGS. 7, 8, 9 and 10 illustrate one method for installing the side seal 146 into the side seal slot 112 utilizing the side seal guide feature as illustrated in FIGS. 4 through 6 and as described herein. As shown in FIG. 7, the side seal 146 may be inserted generally radially through an opening 148 such as an arm-way that extends through the compressor discharge casing 42 and/or the outer turbine casing 48. As shown in FIG. 8, the side seal 146 is lowered such that a top portion 150 of the side seal has generally cleared the compressor discharge casing 42 and/or the outer turbine casing 48. A bottom portion 152 of the side seal 146 is generally aligned with the side seal guide feature 144 generally adjacent to the step 142. The side seal 146 is then manipulated axially with respect to the axial centerline 122 of the aft frame 94 through the side seal guide feature 144 towards the downstream wall 118 into the side seal slot 112. As shown in FIG. 9, the side seal 146 is then inserted radially into the side seal slot 112. Once the side seal is seated in the side seal slot 112, as shown in FIG. 10, the side seal may be coupled to the aft frame 94.

FIGS. 11 and 12 provide a backside view of two adjacent aft frames 94 with the side seal 146 disposed between two adjacent side seal slots 112 as described herein. In particular, FIG. 11 illustrates the side seal 146 being aligned with the side seal slots 112 and FIG. 12 illustrates the side seal 146 fully inserted/installed into the side seal slots 112. This method reduces the radial clearance needed between the compressor discharge casing and/or the outer turbine casing in order to install the side seal without bending and/or twisting the side seal. As a result, the potential for damaging the side seal during installation may be greatly reduced, thereby increasing the mechanical life of the side seal and/or reducing leakage of the compressed working fluid between the high pressure plenum and the hot gas path.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. An aft frame for an annular combustion liner of a gas turbine, comprising;
a. an inner portion radially separated from an outer portion and a pair of opposing sides that extend between the inner and the outer portions;
b. a side seal slot that extends along a first side of the pair of opposing sides between the inner and the outer portions of the aft frame, the side seal slot being at least partially defined between a downstream wall and an upstream wall that extends outward from the first side;
c. wherein a first segment of the upstream wall extends from the inner portion towards the outer portion at a first outward distance, and a second segment of the upstream wall extends from an intersection point with the first segment towards the outer portion of the aft frame at a second outward distance, the second segment of the upstream wall at least partially defining a side seal guide feature to allow for axial insertion of a bottom portion of a side seal into the side seal slot.

2. The aft frame as in claim 1, wherein the first outward distance is greater than the second outward distance.

3. The aft frame as in claim 1, further comprising a step that is defined between an outer surface of the first segment and an outer surface of the second segment.

4. The aft frame as in claim 3, wherein the step is configured to guide the bottom portion of the side seal into the side seal slot in an axial and a radial direction.

5. The aft frame as in claim 1, wherein the first side portion includes an inner surface, wherein the first outward distance, the second outward distance and the third outward distance are each measured along lines that extend generally perpendicular to the inner surface.

6. The aft frame as in claim 1, wherein the downstream wall extends from the inner portion to the outer portion of the aft frame.

7. The aft frame as in claim 6, wherein the downstream wall extends outward from the first side portion a distance that is greater than the second outward distance of the second segment of the upstream wall.

8. The aft frame as in claim 1, wherein a second side of the pair of opposing sides includes a side seal slot.

9. A combustor for a gas turbine, comprising:
a. an end cover coupled to a casing that at least partially surrounds the combustor;
b. a fuel nozzle that extends from the end cover and at least partially through a cap assembly, the cap assembly extending radially and axially within the casing downstream from the end cover;
c. an annular liner having a forward end and an aft end, the forward end surrounding a downstream end of the cap assembly and the aft end being disposed downstream from forward end; and
d. an aft frame that extends circumferentially around and radially outward from the downstream end of the liner to define an outlet from the liner, the aft frame comprising:
i. an inner portion radially separated from an outer portion and a pair of opposing sides that extend between the inner and the outer portions;
ii. a side seal slot that extends along a first side of the pair of opposing sides between the inner and the outer portions of the aft frame, the side seal slot being at least partially defined between a downstream wall and an upstream wall that extend outward from the first side;
iii. wherein a first segment of the upstream wall extends from the inner portion towards the outer portion at a first outward distance from the first side, and a second segment of the upstream wall extends from the first segment to the outer portion at a second outward distance, the second segment of the upstream wall at least partially defining a side seal guide feature to allow for axial insertion of a bottom portion of a side seal into the side seal slot.

10. The combustor as in claim 9, wherein the first outward distance is greater than the second outward distance.

11. The combustor as in claim 9, wherein the first segment of the upstream wall defines a step that extends between an outer surface of the first segment and an outer surface of the second segment.

12. The combustor as in claim 11, wherein the step is configured to guide the bottom portion of the side seal into the side seal slot in an axial direction.

13. The combustor as in claim 9, wherein the first side portion of the aft frame includes an inner surface, wherein the first outward distance and the second outward distance are measured along lines that extend generally perpendicular to the inner surface.

14. The combustor as in claim 9, wherein the downstream wall extends from the inner portion to the outer portion of the aft frame.

15. The combustor as in claim 9, wherein the downstream wall extends outward from the first side portion a third outward distance that is greater than the second outward distance of the second segment of the upstream wall.

16. A gas turbine, comprising:
a. a compressor, a combustion section positioned downstream from the compressor, and a turbine section that is positioned downstream from the combustion section, the combustion section including a compressor discharge casing that at least partially surrounds the combustion section;
b. a combustor that extends through the compressor discharge casing towards an inlet to the turbine section, the combustor having an end cover that is coupled to the compressor discharge casing, an annular cap assembly disposed downstream from the end cover within the compressor discharge casing, and an annular liner having a forward end that surrounds a downstream end of the cap assembly and a downstream end that terminates adjacent to the inlet of the turbine section, the downstream end of the liner having an aft frame that defines an outlet at the downstream end of the liner, the aft frame comprising:
i. an inner portion radially separated from an outer portion and a pair of opposing sides that extend between the inner and the outer portions;
ii. a side seal slot that extends along a first side of the pair of opposing sides between the inner and the outer portions of the aft frame, the side seal slot being at least partially defined between a downstream wall and an upstream wall that extend outward from the first side;
iii. wherein a first segment of the upstream wall extends from the inner portion towards the outer portion at a first outward distance from the first side, and a second segment of the upstream wall extends from the first segment to the outer portion at a second outward distance, the second segment of the upstream wall at least partially defining a side seal guide feature that allows for axial insertion of a bottom portion of a side seal into the side seal slot.

17. The gas turbine as in claim 16, wherein the first outward distance of the first segment of the upstream wall is greater than the second outward distance of the second segment of the upstream wall.

18. The gas turbine as in claim 16, wherein the first segment of the upstream wall defines a step that extends between an outer surface of the first segment and an outer surface of the second segment, the step being configured to guide the bottom portion of the side seal into the side seal slot in an axial and a radial direction.

19. The gas turbine as in claim 16, wherein the downstream wall extends from the inner portion to the outer portion of the aft frame.

20. The gas turbine as in claim 16, wherein the downstream wall extends outward from the first side at an outward distance that is greater than the second outward distance of the second segment of the upstream wall.
